(19) United States
(12) Patent Application Publication
(10) Pub. No.: US 2017/0139251 A1
(43) Pub. Date: May 18, 2017

(54) VA TYPE IN-CELL TOUCH CONTROL DISPLAY PANEL STRUCTURE

(71) Applicant: Shenzhen China Star Optoelectronics Technology Co. Ltd., Shenzhen City (CN)

(72) Inventors: Cong Wang, Shenzhen City (CN); Peng Du, Shenzhen City (CN)

(21) Appl. No.: 14/778,612

(22) PCT Filed: Aug. 24, 2015
(86) PCT No.: PCT/CN2015/087902

§ 371 Date: Sep. 21, 2015

(51) Int. Cl. G02F 1/1333; G02F 1/1335; G02F 1/1343; G06F 3/041

(52) U.S. Cl. CPC G02F 1/13338; G06F 3/0412; G02F 1/133514; G02F 1/133512; G02F 1/134309; G02F 1/13439; G06F 2203/04107; G06F 3/044

(57) ABSTRACT

The present invention provides a VA type In-Cell touch control display panel structure, of which the color filter comprises a black matrix (12) of metal material and a common electrode layer (14). The black matrix (12) at least comprises a plurality of first black matrix vertical zones (121) which are separated along a vertical direction, and each independent first black matrix vertical zone (121) is employed to be a touch acceptance electrode (Rx(n)); the common electrode layer (14) at least comprises a plurality of first common electrode horizontal zones (141), which are separated along a horizontal direction, and each independent first common electrode horizontal zone (141) is employed to be a touch transmittance electrode (Tx(m)). The VA type In-Cell touch control display panel structure of the present invention has a simple manufacture flow which can effectively reduce the production cost and promote the yield of the touch control display panel.

### FIELD OF THE INVENTION

The present invention relates to a display technology field, and more particularly to a VA type In-Cell touch control display panel structure.

### BACKGROUND OF THE INVENTION

With the rapid development of the display technology, the touch control display panel has been widely applied and accepted, used by the people. For example, the smart phone, the flat panel computer and etc. all use the touch control display panel. The touch control display panel is to combine the touch control panel and the liquid display panel as one to make the liquid crystal display panel equipped with functions of display and sensing the touch control inputs at the same time.

Generally, the liquid crystal panel mainly comprises a Color Filter (CF), a Thin Film Transistor Array Substrate (TFT Array Substrate) and a Liquid Crystal Layer positioned inbetween. The working principle is that the light of backlight module is reflected to generate images by applying driving voltages to the two glass substrate for controlling the rotations of the liquid crystal molecules. According to the orientation of the liquid crystal, the liquid crystal display panels in the mainstream market can be categorized into several types, which are Vertical Alignment (VA), Twisted Nematic (TN) or Super Twisted Nematic (STN), In-Plane Switching (IPS) and Fringe Field Switching (FFS).

The touch control display panels can be categorized into four types of resistive, capacitive, optics, surface acoustic wave types according to sensing technology. At present, the main stream touch control technology is the capacitive type. The capacitive type can be further categorized into self capacitive type and mutual capacitive type. The main capacitive type touch control display panel in the present market is the mutual capacitive type, and the advantage of the mutual capacitive type is being able to achieve multi-touch control. The traditional capacitive type touch control display panels can be roughly divided into two kinds: one is to manufacture the touch sensors on the package cover plate on the liquid crystal display panel, and the tempered glass is cut after the manufacture is accomplished, therefore, the demands of cutting is raised and the production cost is increased, and the yield is low; the other is to manufacture the touch sensors on exterior of the cell of the liquid crystal display panel, and the photolithography and etching are performed after the assembly of the TFT substrate and the CF substrate is finished, and the entire process is more complicated, and the yield is low, either.

### SUMMARY OF THE INVENTION

An objective of the present invention is to provide a VA type In-Cell touch control display panel structure of the present invention having a simple manufacture flow which can effectively reduce the production cost and promote the yield of the touch control display panel.

For realizing the aforesaid objective, the present invention provides a VA type In-Cell touch control display panel structure, comprising a color filter and an array substrate which are oppositely positioned and a liquid crystal layer sandwiched between the color filter and the array substrate;

the color filter comprises a substrate, a black matrix of metal material positioned on the substrate, a color resist layer covering the substrate and the black matrix and a common electrode layer covering the color resist layer;

the black matrix at least comprises a plurality of first black matrix vertical zones which are separated along a vertical direction, and each independent first black matrix vertical zone is employed to be a touch acceptance electrode;

the common electrode layer at least comprises a plurality of first common electrode horizontal zones, which are separated along a horizontal direction, and each independent first common electrode horizontal zone is employed to be a touch transmittance electrode.

The black matrix further comprises a second black matrix vertical zone which is positioned between two adjacent first black matrix vertical zones and separated with the two adjacent first black matrix vertical zones, and each independent second black matrix vertical zone is grounded to be a vertical shielding electrode; a width of the first black matrix vertical zone is larger than a width of the second black matrix vertical zone.

The common electrode layer further comprises a second common electrode horizontal zone which is positioned between two adjacent first common electrode horizontal zones and separated with the two adjacent first common electrode horizontal zones, and each independent second common electrode horizontal zone is grounded to be a horizontal shielding electrode; a width of the first common electrode horizontal zone is larger than a width of the second common electrode horizontal zone.

Material of the black matrix is chromium.

Material of the common electrode layer is ITO.

The width of the first black matrix vertical zone is 6 mm, and the width of the first common electrode horizontal zone is 6 mm.

The width of the first black matrix vertical zone is 6 mm, and the width of the second black matrix vertical zone is 1 mm.

The width of the first common electrode horizontal zone is 6 mm, and the width of the second common electrode horizontal zone is 1 mm.

A gap of the common electrode layer is right against the black matrix, and the gap of the common electrode layer is completely shielded by the black matrix.

The array substrate comprises metal lines, and metal lines under the first black matrix vertical zone and the second black matrix vertical zone of the black matrix are completely shielded by the black matrix, and the metal lines under a gap of the black matrix completely shield the gap.

The present invention further provides a VA type In-Cell touch control display panel structure, comprising a color filter and an array substrate which are oppositely positioned and a liquid crystal layer sandwiched between the color filter and the array substrate;

the color filter comprises a substrate, a black matrix of metal material positioned on the substrate, a color resist layer covering the substrate and the black matrix and a common electrode layer covering the color resist layer;

the black matrix at least comprises a plurality of first black matrix vertical zones which are separated along a vertical direction, and each independent first black matrix vertical zone is employed to be a touch acceptance electrode;

the common electrode layer at least comprises a plurality of first common electrode horizontal zones, which are separated along a horizontal direction, and each independent first common electrode horizontal zone is employed to be a touch transmittance electrode;

wherein the black matrix further comprises a second black matrix vertical zone which is positioned between two adjacent first black matrix vertical zones and separated with the two adjacent first black matrix vertical zones, and each independent second black matrix vertical zone is grounded to be a vertical shielding electrode; a width of the first black matrix vertical zone is larger than a width of the second black matrix vertical zone;

wherein the common electrode layer further comprises a second common electrode horizontal zone which is positioned between two adjacent first common electrode horizontal zones and separated with the two adjacent first common electrode horizontal zones, and each independent second common electrode horizontal zone is grounded to be a horizontal shielding electrode; a width of the first common electrode horizontal zone is larger than a width of the second common electrode horizontal zone;

wherein material of the black matrix is chromium;

wherein material of the common electrode layer is ITO;

wherein the width of the first black matrix vertical zone is 6 mm, and the width of the second black matrix vertical zone is 1 mm;

wherein the width of the first common electrode horizontal zone is 6 mm, and the width of the second common electrode horizontal zone is 1 mm;

wherein a gap of the common electrode layer is right against the black matrix, and the gap of the common electrode layer is completely shielded by the black matrix;

wherein the array substrate comprises metal lines, and metal lines under the first black matrix vertical zone and the second black matrix vertical zone of the black matrix are completely shielded by the black matrix, and the metal lines under a gap of the black matrix completely shield the gap.

The benefits of the present invention are: the present invention provides a VA type In-Cell touch control display panel structure. By zoning and separating the black matrix of metal material along the vertical direction, and zoning and separating the common electrode layer along the horizontal direction to employ each independent first black matrix vertical zone to be a touch acceptance electrode, and to employ each independent first common electrode horizontal zone to be a touch transmittance electrode, the integration of the touch control sensors inside the cell is achieved, and the manufacture flow is simple and can effectively reduce the production cost and promote the yield of the touch control display panel; besides, each independent second black matrix vertical zone is grounded to be a vertical shielding electrode, and each independent second common electrode horizontal zone is grounded to be a horizontal shielding electrode, which can enlarge the signal noise ratio and promote the yield of the touch control display panel in advance.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a sectional diagram of a VA type In-Cell touch control display panel structure according to the present invention;

FIG. 2 is a bottom view diagram of the first embodiment of the black matrix and the common electrode layer at one side of the color filter in the VA type In-Cell touch control display panel structure according to the present invention;

FIG. 3 is a bottom view enlarge diagram corresponding to the A position in FIG. 2;

FIG. 4 is a top view enlarge diagram corresponding to the B position in FIG. 2;

FIG. 5 is a top view enlarge diagram corresponding to the C position in FIG. 2;

FIG. 6 is a bottom view diagram of the second embodiment of the black matrix and the common electrode layer at one side of the color filter in the VA type In-Cell touch control display panel structure according to the present invention;

FIG. 7 is a bottom view diagram of the third embodiment of the black matrix and the common electrode layer at one side of the color filter in the VA type In-Cell touch control display panel structure according to the present invention;

FIG. 8 is a sectional diagram of the VA type In-Cell touch control display panel structure according to the present invention as the touch control detection is performed.

### DETAILED DESCRIPTION OF PREFERRED EMBODIMENTS

For better explaining the technical solution and the effect of the present invention, the present invention will be further described in detail with the accompanying drawings and the specific embodiments.

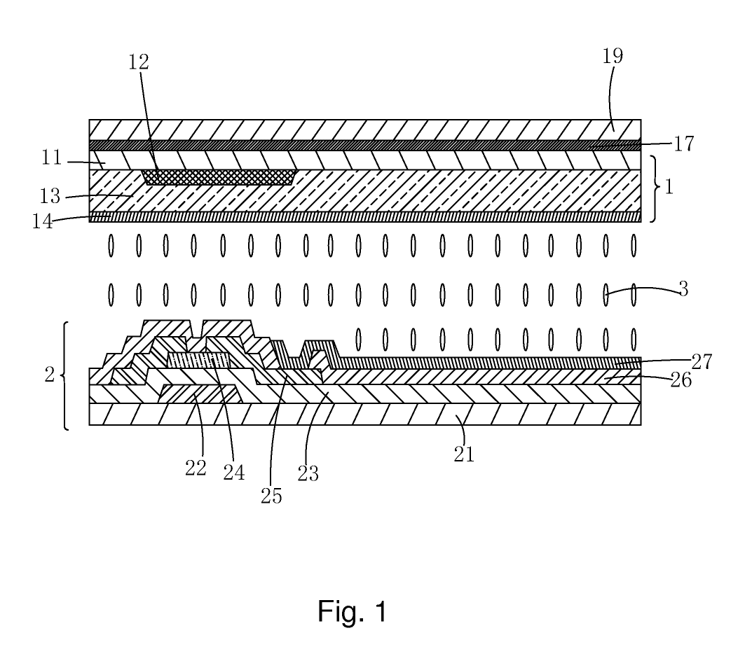

Please refer to FIG. 1. The present invention provides a VA type In-Cell touch control display panel structure, comprising a color filter 1 and an array substrate 2 which are oppositely positioned and a liquid crystal layer 3 sandwiched between the color filter 1 and the array substrate 2.

The color filter 1 comprises a substrate 11, a black matrix 12 of metal material positioned on the substrate 11, a color resist layer 13 covering the substrate 11 and the black matrix 12 and a common electrode layer 14 covering the color resist layer 13. An Optically Clear Adhesive (OCA) 17 is adhered on the surface of the color filter 1 away from the liquid crystal layer 3. One Cover lens 19 is fixed on the Optically Clear Adhesive 17.

The array substrate 2 is the same as the array substrate in the VA type liquid crystal display panel according to prior art, and comprises a substrate 21, a gate 22, a gate isolation layer 23, an island shaped active layer 24, a source/a drain 25, a insulation protective layer 26, a pixel electrode 27, and metal lines, such as scan lines (not shown) and data lines (not shown). The detail description is omitted here.

Material of the black material 12 is metal, and thus the black material 12 is conductive. Preferably, material of the black matrix 12 is chromium (Cr). The color resist layer 13 at least comprises color resists of three colors, red, green, blue. Preferably, material of the common electrode layer 14 is Indium Tin Oxide (ITO). The color resist layer 13 is positioned between the black matrix 12 and the common electrode layer 14 to act for insulation function.

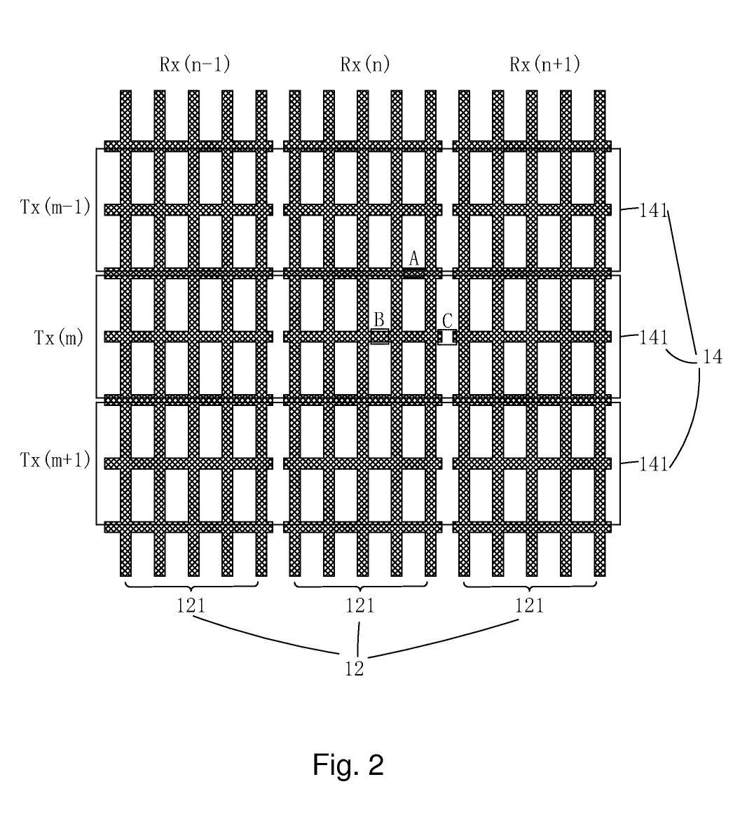

FIG. 2 is a diagram of the first embodiment of the black matrix 12 and the common electrode layer 14 at one side of the color filter 1 in the VA type In-Cell touch control display panel structure according to the present invention. In the first embodiment:

the black matrix 12 at least comprises a plurality of first black matrix vertical zones 121 which are separated along a vertical direction, and each independent first black matrix vertical zone 121 is employed to be a touch acceptance electrode Rx(n), and n is a positive integer.

The common electrode layer 14 at least comprises a plurality of first common electrode horizontal zones 141, which are separated along a horizontal direction, and each independent first common electrode horizontal zone 141 is employed to be a touch transmittance electrode Tx(m), and m is a positive integer.

Preferably, the width of the first black matrix vertical zone 121 is 6 mm, and the width of the first common electrode horizontal zone 141 is 6 mm.

The plurality of first black matrix vertical zones 121 which are separated along the vertical direction and the plurality of first common electrode horizontal zones 141, which are separated along the horizontal direction interlace with one another in space, i.e. the multiple touch acceptance electrodes Rx(n) and the multiple touch transmittance electrodes Tx(m) interlace with one another in space to form the touch control sensors integrated inside the cell.

AS manufacturing the black matrix 12 and the common electrode layer 14, merely two masks are added on the basis of the regular manufacture process for respectively zoning and separating the black matrix 12 and the common electrode layer 14. The manufacture flow is simple and can effectively reduce the production cost and promote the yield of the touch control display panel.

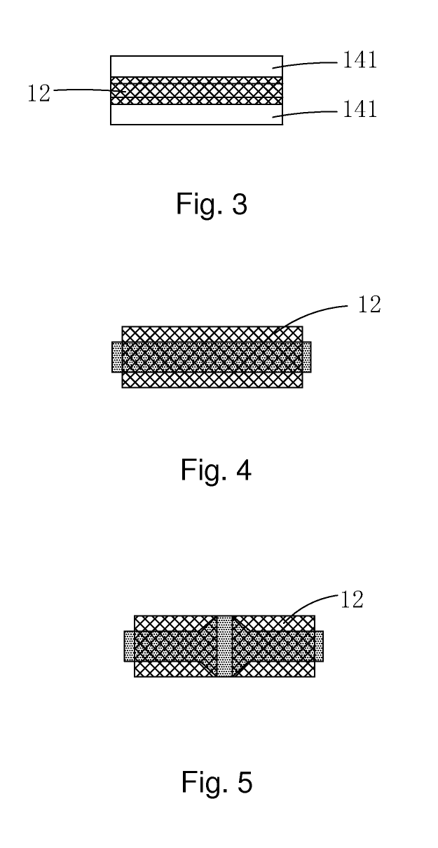

Furthermore, please refer from FIG. 3 to FIG. 5. For preventing the light leak: a gap of the common electrode layer 14 is right against the black matrix 12, and the gap of the common electrode layer 14 is completely shielded by the black matrix 12; metal lines in the array substrate under the first black matrix vertical zone 121 of the black matrix 12 are completely shielded by the black matrix 12; the metal lines in the array substrate under respective gaps of the black matrix 12 are widened to completely shield the gap for acting the shielding result and ensuring the normal display of the panel.

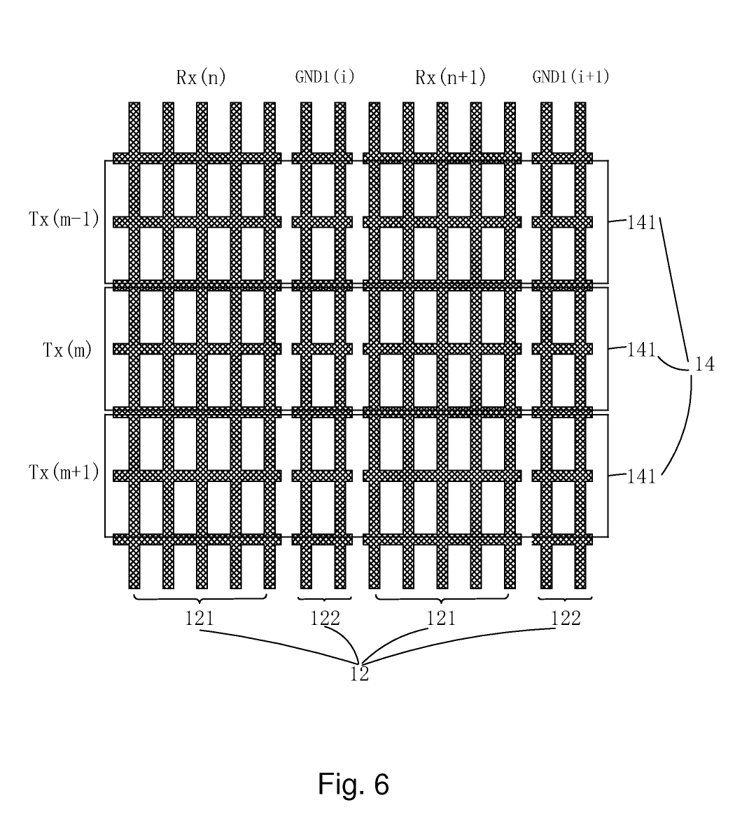

FIG. 6 is a diagram of the second embodiment of the black matrix 12 and the common electrode layer 14 at one side of the color filter 1 in the VA type In-Cell touch control display panel structure according to the present invention. The difference between the second embodiment and the first embodiment is that, the black matrix 12 further comprises a second black matrix vertical zone 122 which is positioned between two adjacent first black matrix vertical zones 121 and separated with the two adjacent first black matrix vertical zones 121, and each independent second black matrix vertical zone 122 is grounded to be a vertical shielding electrode GND1(i), and i is a positive integer.

A width of the first black matrix vertical zone 121 is larger than a width of the second black matrix vertical zone 122. Preferably, the width of the first black matrix vertical zone 121 is 6 mm, and the width of the second black matrix vertical zone 122 is 1 mm.

Metal lines under the first black matrix vertical zone 121 and the second black matrix vertical zone 122 of the black matrix 12 are completely shielded by the black matrix 12, and the metal lines under respective gaps of the black matrix 12 completely shield the gaps.

The reset is the same as the first embodiment. The repeated description is omitted here.

The second embodiment provides the second black matrix vertical zone 122 to be grounded for being the vertical shielding electrode GND1(i), which can enlarge the signal noise ratio and promote the yield of the touch control display panel in advance.

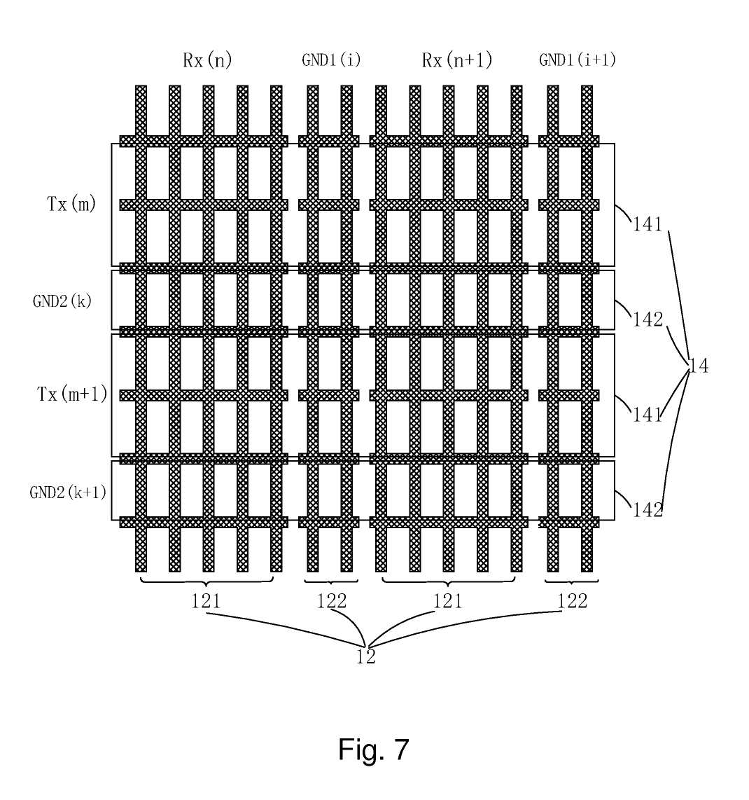

FIG. 7 is a diagram of the third embodiment of the black matrix 12 and the common electrode layer 14 at one side of the color filter 1 in the VA type In-Cell touch control display panel structure according to the present invention. The difference between the third embodiment and the second embodiment is that, the common electrode layer 14 further comprises a second common electrode horizontal zone 142 which is positioned between two adjacent first common electrode horizontal zones 141 and separated with the two adjacent first common electrode horizontal zones 141, and each independent second common electrode horizontal zone 142 is grounded to be a horizontal shielding electrode GND2(k), and k is a positive integer.

A width of the first common electrode horizontal zone 141 is larger than a width of the second common electrode horizontal zone 142. Preferably, the width of the first common electrode horizontal zone 141 is 6 mm, and the width of the second common electrode horizontal zone 142 is 1 mm.

The reset is the same as the second embodiment. The repeated description is omitted here.

On the basis that the second black matrix vertical zone 122 is provided to be grounded for being the vertical shielding electrode GND1(i), the third embodiment additionally provides the second common electrode horizontal zone 142 to be grounded for being the horizontal shielding electrode GND2(k). The signal noise ratio can be more enlarged and the yield of the touch control display panel can be higher.

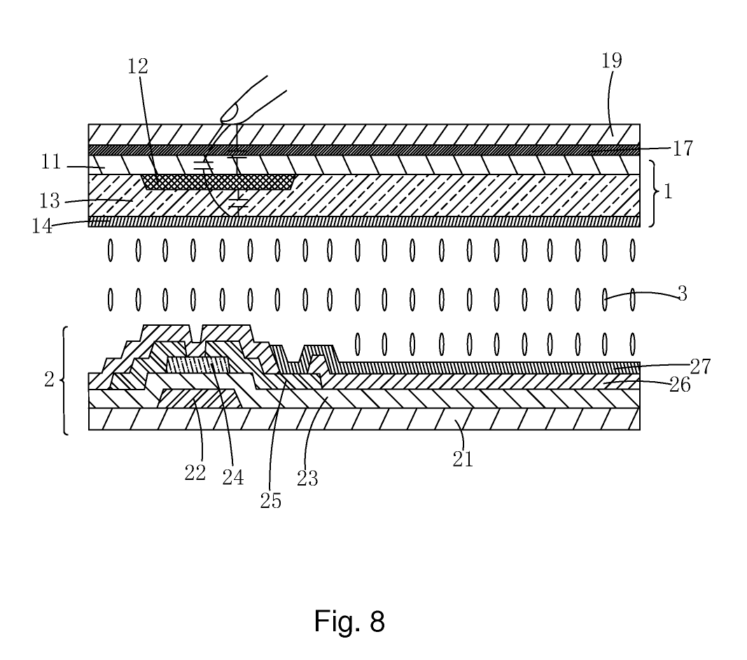

With combination of FIG. 1 and FIG. 8, as the VA type In-Cell touch control display panel structure of the present invention normally displays in VA mode, as shown in FIG. 1, no signals enter the black matrix 12 of metal material, and the black matrix 12 merely acts for shielding light, and the common electrode 14 and the pixel electrode 27 form an electrical field, which does not influence the normal display of the touch control display panel. As performing the touch control detection, as shown in FIG. 8, the first black matrix vertical zone 121 of the black matrix 12 is employed to be the touch acceptance electrode Rx(n), and the first common electrode horizontal zone 141 of the common electrode layer 14 is employed to be the touch transmittance electrode Tx(m) to form a capacitance; as the finger touches the screen, the finger respectively form capacitances with the touch transmittance electrode and the touch acceptance electrode to form difference between the capacitance of the touch control position and the capacitance of the non-touch control position for realizing the touch point detection thereby.

In conclusion, in the VA type In-Cell touch control display panel structure of the present invention, by zoning and separating the black matrix of metal material along the vertical direction, and zoning and separating the common electrode layer along the horizontal direction to employ each independent first black matrix vertical zone to be a touch acceptance electrode, and to employ each independent first common electrode horizontal zone to be a touch transmittance electrode, the integration of the touch control sensors inside the cell is achieved, and the manufacture flow is simple and can effectively reduce the production cost and promote the yield of the touch control display panel; besides, each independent second black matrix vertical zone is grounded to be a vertical shielding electrode, and each independent second common electrode horizontal zone is grounded to be a horizontal shielding electrode, which can enlarge the signal noise ratio and promote the yield of the touch control display panel in advance.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A VA type In-Cell touch control display panel structure, comprising a color filter and an array substrate which are oppositely positioned and a liquid crystal layer sandwiched between the color filter and the array substrate;
the color filter comprises a substrate, a black matrix of metal material positioned on the substrate, a color resist layer covering the substrate and the black matrix and a common electrode layer covering the color resist layer;
the black matrix at least comprises a plurality of first black matrix vertical zones which are separated along a vertical direction, and each independent first black matrix vertical zone is employed to be a touch acceptance electrode;
the common electrode layer at least comprises a plurality of first common electrode horizontal zones, which are separated along a horizontal direction, and each independent first common electrode horizontal zone is employed to be a touch transmittance electrode.

2. The VA type In-Cell touch control display panel structure according to claim 1, wherein the black matrix further comprises a second black matrix vertical zone which is positioned between two adjacent first black matrix vertical zones and separated with the two adjacent first black matrix vertical zones, and each independent second black matrix vertical zone is grounded to be a vertical shielding electrode; a width of the first black matrix vertical zone is larger than a width of the second black matrix vertical zone.

3. The VA type In-Cell touch control display panel structure according to claim 1, wherein the common electrode layer further comprises a second common electrode horizontal zone which is positioned between two adjacent first common electrode horizontal zones and separated with the two adjacent first common electrode horizontal zones, and each independent second common electrode horizontal zone is grounded to be a horizontal shielding electrode; a width of the first common electrode horizontal zone is larger than a width of the second common electrode horizontal zone.

4. The VA type In-Cell touch control display panel structure according to claim 2, wherein the common electrode layer further comprises a second common electrode horizontal zone which is positioned between two adjacent first common electrode horizontal zones and separated with the two adjacent first common electrode horizontal zones, and each independent second common electrode horizontal zone is grounded to be a horizontal shielding electrode; a width of the first common electrode horizontal zone is larger than a width of the second common electrode horizontal zone.

5. The VA type In-Cell touch control display panel structure according to claim 1, wherein material of the black matrix is chromium.

6. The VA type In-Cell touch control display panel structure according to claim 1, wherein material of the common electrode layer is ITO.

7. The VA type In-Cell touch control display panel structure according to claim 1, wherein the width of the first black matrix vertical zone is 6 mm, and the width of the first common electrode horizontal zone is 6 mm.

8. The VA type In-Cell touch control display panel structure according to claim 2, wherein the width of the first black matrix vertical zone is 6 mm, and the width of the second black matrix vertical zone is 1 mm.

9. The VA type In-Cell touch control display panel structure according to claim 3, wherein the width of the first common electrode horizontal zone is 6 mm, and the width of the second common electrode horizontal zone is 1 mm.

10. The VA type In-Cell touch control display panel structure according to claim 4, wherein the width of the first common electrode horizontal zone is 6 mm, and the width of the second common electrode horizontal zone is 1 mm.

11. The VA type In-Cell touch control display panel structure according to claim 3, wherein a gap of the common electrode layer is right against the black matrix, and the gap of the common electrode layer is completely shielded by the black matrix.

12. The VA type In-Cell touch control display panel structure according to claim 4, wherein a gap of the common electrode layer is right against the black matrix, and the gap of the common electrode layer is completely shielded by the black matrix.

13. The VA type In-Cell touch control display panel structure according to claim 3, wherein the array substrate comprises metal lines, and metal lines under the first black matrix vertical zone and the second black matrix vertical zone of the black matrix are completely shielded by the black matrix, and the metal lines under a gap of the black matrix completely shield the gap.

14. The VA type In-Cell touch control display panel structure according to claim 4, wherein the array substrate comprises metal lines, and metal lines under the first black matrix vertical zone and the second black matrix vertical zone of the black matrix are completely shielded by the black matrix, and the metal lines under a gap of the black matrix completely shield the gap.

15. A VA type In-Cell touch control display panel structure, comprising a color filter and an array substrate which are oppositely positioned and a liquid crystal layer sandwiched between the color filter and the array substrate;
the color filter comprises a substrate, a black matrix of metal material positioned on the substrate, a color resist layer covering the substrate and the black matrix and a common electrode layer covering the color resist layer;
the black matrix at least comprises a plurality of first black matrix vertical zones which are separated along a vertical direction, and each independent first black matrix vertical zone is employed to be a touch acceptance electrode;
the common electrode layer at least comprises a plurality of first common electrode horizontal zones, which are separated along a horizontal direction, and each independent first common electrode horizontal zone is employed to be a touch transmittance electrode;
wherein the black matrix further comprises a second black matrix vertical zone which is positioned between two adjacent first black matrix vertical zones and separated with the two adjacent first black matrix vertical zones, and each independent second black matrix vertical zone is grounded to be a vertical shielding electrode; a width of the first black matrix vertical zone is larger than a width of the second black matrix vertical zone;
wherein the common electrode layer further comprises a second common electrode horizontal zone which is positioned between two adjacent first common electrode horizontal zones and separated with the two adjacent first common electrode horizontal zones, and each independent second common electrode horizontal zone is grounded to be a horizontal shielding electrode; a width of the first common electrode horizontal zone is larger than a width of the second common electrode horizontal zone;
wherein material of the black matrix is chromium;
wherein material of the common electrode layer is ITO;
wherein the width of the first black matrix vertical zone is 6 mm, and the width of the second black matrix vertical zone is 1 mm;
wherein the width of the first common electrode horizontal zone is 6 mm, and the width of the second common electrode horizontal zone is 1 mm;
wherein a gap of the common electrode layer is right against the black matrix, and the gap of the common electrode layer is completely shielded by the black matrix;
wherein the array substrate comprises metal lines, and metal lines under the first black matrix vertical zone and the second black matrix vertical zone of the black matrix are completely shielded by the black matrix, and the metal lines under a gap of the black matrix completely shield the gap.
